(19) United States
(12) Patent Application Publication
(10) Pub. No.: US 2013/0266832 A1
(43) Pub. Date: Oct. 10, 2013

(54) BATTERY

(71) Applicants: Atsushi Shirasawa, Sunto-gun (JP); Shigenori Hama, Susono-shi (JP)

(72) Inventors: Atsushi Shirasawa, Sunto-gun (JP); Shigenori Hama, Susono-shi (JP)

(73) Assignee: TOYOTA JIDOSHA KABUSHIKI KAISHA, Toyota-shi, Aichi-ken (JP)

(21) Appl. No.: 13/988,590

(22) PCT Filed: Dec. 22, 2011
(86) PCT No.: PCT/IB2011/003116

§ 371 Date: May 21, 2013

(30) Foreign Application Priority Data
Dec. 28, 2010 (JP) 2010-292626
Feb. 15, 2011 (JP) 2011-029901

(51) Int. Cl. H01M 10/52

(52) U.S. Cl. CPC H01M 10/52
USPC 429/61

(57) ABSTRACT

A battery that includes a battery cell and a case within which the battery cell is housed, and in which a gas that pressurizes the battery cell is filled into the case, also includes a pressure controlling mechanism capable of controlling pressure inside of the case.

### BACKGROUND OF THE INVENTION

1. Field of the Invention

The invention relates to a battery in which a battery cell housed in a case is pressurized by a gas.

2. Description of Related Art

Lithium-ion secondary batteries are capable of operating at a higher voltage and greater energy density than other secondary batteries. Therefore, they are used in information devices such as mobile phones, as secondary batteries that can easily be made small and lightweight, and in recent years there has also been an increasing demand to use them to power larger objects such as electric vehicles and hybrid vehicles.

A lithium-ion secondary battery has a positive-electrode layer, a negative-electrode layer, and an electrolyte layer arranged between the positive-electrode layer and the negative-electrode layer. A non-aqueous solution or a solid may be used as the electrolyte provided for the electrolyte layer. If a solution is used for the electrolyte (hereinafter, referred to as an “electrolyte solution”), the electrolyte solution tends to penetrate the positive- and negative-electrode layers. As a result, a boundary tends to form between the electrolyte solution and the active material in the positive- and negative-electrode layers, so performance is easily improved. However, the electrolyte solution that is widely used is flammable, so there needs to be a system to ensure safety. On the other hand, an electrolyte that is a solid (hereinafter, referred to as a “solid electrolyte”) is nonflammable, so the system can be simplified. Thus, a lithium-ion secondary battery with a layer of a nonflammable solid electrolyte has been proposed.

Japanese Patent Application Publication No. 10-214638 (JP-A-10-214638), for example, describes technology related to such a lithium-ion secondary battery. More specifically, JP-A-10-214638 describes a lithium-ion secondary battery in which, in a battery pack in which a plurality of unit cells (battery cells), each of which is formed by a non-aqueous electrolyte solution, and a negative-electrode and a positive electrode with respect to which lithium is able to be inserted and extracted, and a case in which these are all housed, are combined and housed in a battery pack case (i.e., a case), the unit cells are pressurized using static pressure generated within the battery pack case, by filling at least one of a gas, a liquid, and a solid powder, or a combination thereof, into a space inside of the battery pack case but outside of the unit cell cases.

Also, Japanese Patent Application Publication No. 2008-226807 (JP-A-2008-226807) describes a non-aqueous electrolyte secondary battery that includes a gas-forming agent on the surface or inside of at least one layer selected from a group consisting of a positive-electrode active material layer, an electrolyte layer, and a negative-electrode active material layer, and that forms gas from the gas-forming agent when the temperature of the secondary battery reaches equal to or greater than 60° C. and less than 300° C.

As described above, the need for lithium-ion secondary batteries as sources of large amounts of power is increasing, so there is a need for the development of a large capacity lithium-ion secondary battery. In order to increase the capacity of a lithium-ion secondary battery, it is possible to form a battery by connecting a plurality of battery cells together in series or in parallel, like the battery described in JP-A-10-214638. Also, in order to ensure performance while increasing the size of the battery, it is preferable to pressurize the battery cells that are connected together as described above, in order to reduce the electrical resistance within the battery cells. The battery described in JP-A-10-214638 pressurizes the battery cells using static pressure produced inside of the case, by filling at least one of a gas, a liquid, and a solid powder, or a combination thereof, into a space inside of the case.

When battery cells are pressurized using static pressure, as they are in the battery described in JP-A-10-214638, it is preferable to use a gas as the medium for transferring the static pressure, from the viewpoint of suppressing a decrease in mass energy density. However, with a gas, the pressure tends to change in response to a change in temperature, compared with a liquid or the like, when the volume is constant. That is, when a gas is used as the medium for transferring the static pressure, the pressure of the gas tends to change according to external factors such as temperature, so the pressure applied to the battery cells also tends to change. If the fluctuation in the pressure applied to the battery cells is large, it may cause problems, e.g., the battery may become difficult to control. For example, if the pressure applied to the battery cells becomes too low, the battery characteristics of the battery cells may decrease. On the other hand, if the pressure applied to the battery cells becomes too high, the battery cells and the case in which the battery cells are housed may crack, and the battery characteristics of the battery cells may change. With the technologies described in JP-A-10-214638 and JP-A-2008-226807, this type of problem is not taken into consideration, and thus had been unable to be resolved.

### SUMMARY OF THE INVENTION

This invention provides a battery that pressurizes a battery cell housed within a case using a gas, and that is capable of reducing fluctuations in pressure within the case.

A first aspect of the invention relates to a battery that includes a battery cell, a case in which the battery cell is housed and that is filled with a gas that pressurizes the battery cell, and a pressure controlling mechanism capable of controlling pressure inside of the case.

In the invention, the battery cell refers to a structure that includes a positive-electrode layer, a negative-electrode layer, and an electrolyte arranged between the positive-electrode layer and the negative-electrode layer, and that extracts electrical energy generated by the movement of ions and electrons produced by an electrochemical reaction to the outside. Also, in the invention, the case is a sealable container that houses the battery cell and that can be filled with a gas for pressurizing the battery cell. Furthermore, the inside of the case refers to a space inside of the case that is filled with the gas for pressurizing the battery cell, except for the space where a container, that will be described later, is provided.

Also, in the battery described above, the pressure controlling mechanism may include at least one container that the gas inside of the case is able to flow into and out of. Also, the at least one container may allow the gas to flow in and out via an opening and closing portion, and the opening and closing portion may open and close based on a pressure inside of the case, a pressure inside of the container, or a difference in the pressure inside of the case and the pressure inside of the container.

Also, in the battery described above, the at least one container may be a plurality of containers, and each of the plurality of containers may allow the gas inside of the case to flow in and out via a different opening and closing portion for each container.

Also, in the battery provided with the container, the container may be provided inside of the case.

Also, in the battery provided with the container, the container may be provided outside of the case.

Also, in the battery provided with the container, a volume of the container may be variable.

In the invention, the volume of the container refers to the volume of the space inside of the case.

Also, in the battery provided with the container, the pressure controlling mechanism may include a delivery portion that forcibly delivers the gas inside of the case into the container.

Also, in the battery provided with the container, the pressure controlling mechanism may include a discharging portion that forcibly discharges gas inside of the container into the case.

Also, in the battery described above, the pressure controlling mechanism may include a releasing portion capable of releasing gas inside of the case outside of the case based on the pressure inside of the case, and a supply portion capable of supplying gas into the case based on the pressure inside of the case.

This invention is thus able to provide a battery that pressurizes a battery cell housed within a case using a gas, and that is capable of reducing fluctuations in pressure within the case.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view schematically showing the structure of a battery according to a first example embodiment of the invention; and

FIG. 2 is a view schematically showing the structure of a battery according to a second example embodiment of the invention.

### DETAILED DESCRIPTION OF EMBODIMENTS

### 1. First Example Embodiment

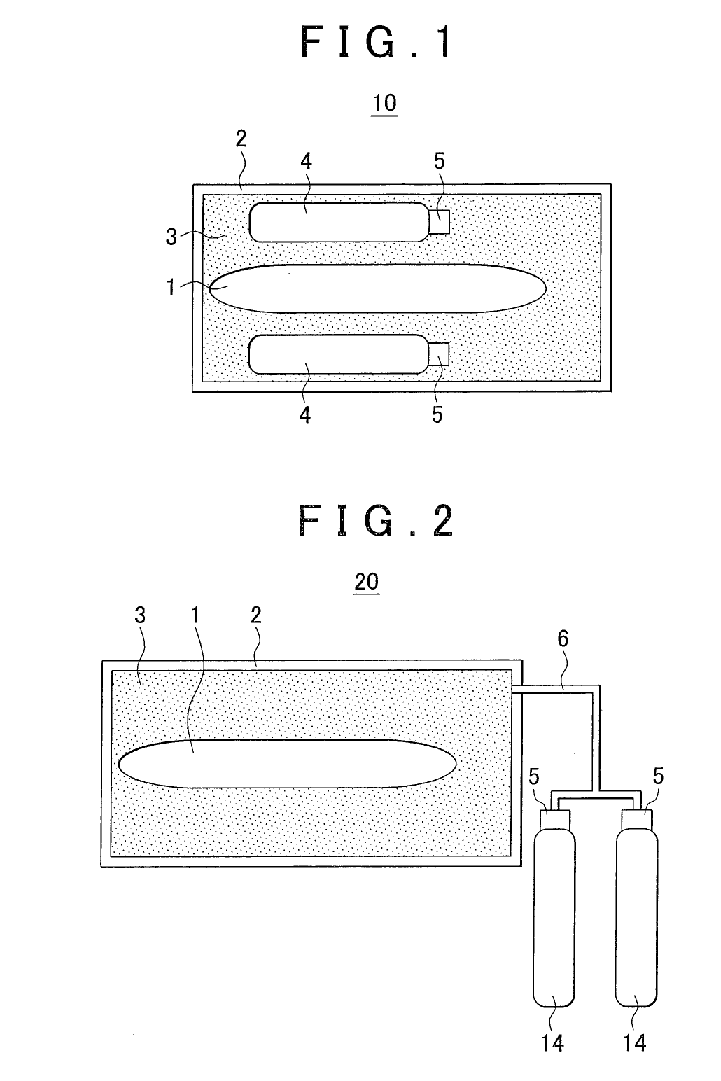

FIG. 1 is a view schematically showing the structure of a battery 10 according to a first example embodiment of the invention. The battery 10 includes a battery pack 1 and a case 2 within which the battery pack 1 is housed. Also, a gas 3 that pressurizes the battery pack 1 is filled inside of the case 2. The battery 10 also includes a container 4 that the gas 3 in the case 2 is able to flow into and out of via opening/closing means 5. Moreover, the battery 10 includes a pressure controlling mechanism capable of controlling the pressure inside of the case 2. The opening/closing means 5 and the container 4 are included in this pressure controlling mechanism, as will be described later. These elements that make up the battery 10 will be described below.

(Battery Pack 1)

The battery pack 1 is formed by a plurality of battery cells that have been combined. Also, each of the battery cells includes a positive-electrode layer, a negative-electrode layer, and an electrolyte layer that is arranged between the positive-electrode layer and the negative-electrode layer. The positive-electrode layer is a layer that includes at least positive-electrode active material, and a positive-electrode collector is arranged on a surface of this positive-electrode layer. The negative-electrode layer is a layer that includes at least negative-electrode active material, and a negative-electrode collector is arranged on a surface of this negative-electrode layer. As this type of battery cell, a battery cell used in a conventional battery may be used with no particular restrictions. Also, the number of battery cells in the battery pack 1 is not particularly limited. Furthermore, the connection method of the battery cells in the battery pack is also not particularly limited, i.e., the battery cells in the battery pack may be connected according to any known method. FIG. 1 shows a mode in which one battery pack 1 is housed inside of the case 2, but the number of battery packs 1 housed inside of the case 2 is not particularly limited.

In the invention, the manufacturing method of the battery cells described above is not particularly limited. That is, any known method may be used as appropriate. For example, a positive-electrode layer may be formed on the surface of the positive-electrode collector by arranging and pressing positive-electrode material that includes positive-electrode active material and a solid electrolyte onto the surface of the positive-electrode collector, a negative-electrode layer may be formed on the surface of the negative-electrode collector by arranging and pressing negative-electrode material that includes negative-electrode active material and a solid electrolyte onto the surface of the negative-electrode collector, and a solid electrolyte layer may be formed by arranging and pressing a solid electrolyte onto the surface of the positive-electrode layer. Forming the positive-electrode layer, the negative-electrode layer, and the solid electrolyte layer in this way enables a battery cell to be manufactured by forming a stacked body, which is accomplished by stacking a positive-electrode collector that has a solid electrolyte layer and a positive-electrode layer formed on its surface, together with a negative-electrode collector that has a negative-electrode layer formed on its surface, such that the solid electrolyte layer is arranged between the positive-electrode layer and the negative-electrode layer, and then housing the pressed stacked body in an external case.

In the battery pack 1, well-known positive-electrode active material represented by lithium cobalt oxide, for example, may be used as appropriate for the positive-electrode active material in the positive-electrode layer of the battery cell. Also, aside from an oxide solid electrolyte such as Li₃PO₄, a well-known solid electrolyte such as Li₃PS₄ or a sulfide solid electrolyte that is made by mixing Li₂S and P₂S₅ such that Li₂S:P₂S₅=50:50 to 100:0 (for example, a sulfide solid electrolyte made by mixing Li₂S and P₂S₅ such that the mass ratio is Li₂S:P₂S₅=70:30), may be used as appropriate as the solid electrolyte in the positive-electrode layer. In addition, the positive-electrode layer may also include well-known conductive material such as acetylene black.

Also, in the battery pack 1, as the negative-electrode active material in the negative-electrode layer of the battery cell, well-known negative-electrode active material represented by graphite, for example, may be used as appropriate. Also, as the solid electrolyte in the negative-electrode layer, material similar to the solid electrolyte described above that can be used in the positive-electrode layer may be used. In addition, the negative-electrode layer may also include well-known conductive material such as acetylene black.

Also, in the battery pack 1, material similar to the solid electrolyte described above that can be used in the positive-electrode layer and the negative-electrode layer may be used as the solid electrolyte that is used in the solid electrolyte layer of the battery cell.

Also, in the battery pack 1, a well-known collector that can be used in a battery, such as Al foil, Cu foil, Ni foil, Fe foil, CuNi foil, and CuFe foil or the like, may be used as appropriate for the positive-electrode collector and the negative-electrode collector.

Further, in the battery pack 1, the external case that houses the battery cell is preferably strong enough so that it will not break from the pressure of the gas 3, described later, and is preferably flexible enough so that it can transfer the pressure from the gas 3 to the positive-electrode layer, the negative-electrode layer, and the electrolyte layer and the like inside. A well-known external case that can be used with a battery may be used as appropriate for this kind of external case.

FIG. 1 shows a mode in which the battery 10 includes the battery pack 1 that is made from a plurality of battery cells that have been combined, but the invention is not limited to this. That is, the battery 10 may also be provided with a single battery cell instead of the battery pack 1.

(Case 2)

The case 2 is a container that houses the battery pack 1 and is filled with the gas 3 that pressurizes the battery pack 1. This case is constructed to be able to withstand the pressure of the gas 3. The method for filling the gas 3 into the case 2 is not particularly limited. For example, a supply port having a valve that can open and close appropriately may be provided, and the gas 3 may be filled into the case 2 through this supply port. Although not shown, a current terminal that is necessary for the battery, and an inlet and outlet of a conduit and the like and a sensor that will be described later, are provided in this case 2.

(Gas 3)

The gas 3 is a gas that pressurizes the battery pack 1 inside of the case 2. Having the battery pack 1 be pressurized by the gas 3 pressurizes the entire battery pack 1 at a substantially even pressure, which makes it easy to ensure high battery performance, while suppressing a decrease in mass energy density of the battery 10.

For the gas 3 used in this embodiment, a gas that will not react with members in the case 2 in a way that inhibits the use of the battery 10 may be used. Specific examples of this type of gas are inert gases such as dry air, nitrogen, and carbon dioxide.

(Pressure Controlling Mechanism)

The pressure controlling mechanism provided in the battery 10 includes the opening/closing means 5 and the container 4, as will be described below.

The container 4 is a container provided inside of the case 2. Also, the gas 3 inside of the case 2 is able to flow into and out of the container 4 via the opening/closing means 5. The opening/closing means 5 opens and closes based on the pressure inside of the case 2, the pressure inside the container 4, or the difference between the pressure inside of the case 2 and the pressure inside the container 4.

The difference between the pressure inside of the case 2 and the pressure inside the container 4 is produced as described below, for example. When the temperature of the gas 3 inside of the case 2 rises due to heat outside of the case 2 or heat generated by the battery pack 1 or the like, the pressure inside of the case 2 rises. However, the heat of the gas 3 inside of the case 2 is not quickly transferred into the container 4, so a temperature difference occurs between the inside of the case 2 and the inside of the container 4. This temperature difference causes a pressure difference between the inside of the case 2 and the inside of the container 4. Also, when heat inside of the case 2 is released outside of the case 2, the pressure inside of the case 2 decreases. However, heat inside of the container 4 is not quickly absorbed by the gas 3 inside of the case 2, so a temperature difference occurs between the inside of the case 2 and the inside of the container 4. This temperature difference causes a pressure difference between the inside of the case 2 and the inside of the container 4. That is, the difference between the pressure inside of the case 2 and the pressure inside of the container 4 is caused by a difference between the temperature inside of the case 2 and the temperature inside of the container 4. Therefore, in order to make it easier for this pressure difference to occur, the container 4 is preferably made of heat insulating material. Also, a difference between the pressure inside of the case 2 and the pressure inside of the container 4 can also be produced by changing the volume of the space that takes the gas 3 inside the container 4 (hereinafter, referred to as the “capacity of the container 4”), while the opening/closing means 5 is closed. The means for changing the capacity of the container 4 is not particularly limited. For example, a piston or the like may be provided inside the container 4.

A simple example of the opening/closing means 5 is a structure that is formed by a valve that closes by being pushed toward the inside of the container 4 by an elastic body or the like, and a valve that is closed by being pushed toward the outside of the container 4 by an elastic body or the like. According to this structure, the pressure inside of the container 4 becomes a negative pressure with respect to the pressure inside of the case 2, as a result of the pressure inside of the case 2 increasing. When the difference between the pressure inside of the case 2 and the pressure inside of the container 4 becomes greater than a predetermined amount (i.e., the force with which the elastic body or the like pushes the valve), one valve opens such that the gas 3 inside of the case 2 flows into the container 4, thereby enabling the pressure inside of the case 2 to be reduced. Conversely, the pressure inside of the case 2 becomes a negative pressure with respect to the pressure inside of the container 4 as a result of the pressure inside of the case 2 decreasing. When the difference between the pressure inside of the case 2 and the pressure inside of the container 4 becomes greater than a predetermined amount (i.e., the force with which the elastic body or the like pushes the valve), the other valve opens such that the gas 3 flows from inside the container 4 into the case 2, thereby enabling the pressure inside of the case 2 to be increased.

The opening/closing means 5 is not limited to being controlled open and closed by a mechanical mechanism as in the example described above. That is, the opening/closing means 5 may also be controlled open and closed by an electrical mechanism, as described below. That is, the pressure inside of the case 2 and/or the pressure inside of the container 4 may be measured, and a valve that opens and closes in response to an electrical signal based on the measurement results may be used as the opening/closing means 5. In this way, when controlling the opening and closing of the opening/closing means 5 by an electrical mechanism, the opening/closing means 5 can be opened and closed when the pressure inside of the case 2, the pressure inside of the container 4, or the pressure difference between the pressure inside of the case 2 and the pressure inside of the container 4, becomes a predetermined value.

When measuring the pressure inside of the case 2 and/or the pressure inside of the container 4, the measuring means is not particularly limited. A well-known sensor, not shown, may be used as the measuring means. The difference between the pressure inside of the case 2 and the pressure inside of the container 4 may be calculated by measuring the pressure inside of the case 2 and the pressure inside of the container 4 using the well-known sensor.

When the fluctuation in the pressure inside of the case 2 is relatively small, the gas 3 will flow into and out of the case 2 and the container 4 by the natural flow of the gas 3 that occurs as the opening/closing means 5 is opened, as described above, thereby reducing fluctuation in the pressure inside of the case 2 (i.e., the pressure of the gas 3 that pressurizes the battery pack 1), which in turn makes it possible to suppress a fluctuation in the battery characteristics. A case in which the fluctuation in the pressure in the case 2 is relatively small may be, for example, a case that considers only the environment temperature around the battery 10 as a factor of the fluctuation in the pressure of the gas 3 inside of the case 2.

On the other hand, if the fluctuation in the pressure inside of the case 2 is relatively large, it is preferable to forcibly generate a flow of the gas 3 between the case 2 and the container 4 by providing delivering means, not shown, for forcibly delivering the gas 3 inside of the case 2 into the container 4 when the opening/closing means 5 is open, and discharging means, not shown, for forcibly discharging the gas 3 from the container 4 into the case 2. This mode makes it possible to deal with a case in which the pressure inside of the case 2 has greatly fluctuated. The delivering means and the discharging means are not particularly limited. For example, a well-known pump or the like may be used. A case in which the fluctuation in the pressure inside of the case 2 is relatively large may be, for example, a case in which the battery 10 is provided in a vehicle or the like, and it is thought that the case 2 may be deformed due to a collision of the vehicle or the like, a case in which the amount of heat generated by the battery pack 1 is large, a case in which it is thought that the battery pack 1 may short, and a case in which it is assumed that there is a large temperature change when the battery 10 is used, such as when the battery 10 is used for starting at a low temperature (such as approximately −30° C.).

The number of containers 4 provided in the battery 10 is not particularly limited, i.e., one, or two or more may be provided. When a plurality of the containers 4 are provided, the containers 4 preferably allow the gas 3 to flow in and out via different opening/closing means 5 for each container 4. This enables the load on one opening/closing means 5 to be reduced. Also, providing a plurality of the containers 4 makes it easier to finely and quickly control the pressure inside of the case 2.

When a plurality of the containers 4 allow the gas 3 to flow in and out via different opening/closing means 5 for each container 4, the opening and closing conditions for these opening/closing means 5 may be the same or different. Here, when the opening and closing conditions are the same, it means that, when the opening/closing means 5 opens and closes when the pressure inside of the case 2, the pressure inside of the container 4, or the difference between the pressure inside of the case 2 and the pressure inside of the container 4 has reached a predetermined value, this predetermined value is the same. When the opening and closing conditions of the opening/closing means 5 are the same in this way, all of the plurality of opening/closing means 5 may open and close simultaneously, or the order in which they open and close may be specified.

Also, the volume of the container 4 may be variable. Changing the volume of the container 4 while the opening/closing means 5 is closed makes it possible to change the volume inside of the case 2 (i.e., change the amount of space into which the gas 3 is filled inside of the case 2, excluding the space where the container 4 is provided), and thus control the pressure inside of the case 2. Also, the pressure inside of the case 2 can be changed also by changing the capacity of the container 4, while keeping the volume of the container 4 constant when the opening/closing means 5 is open. One conceivable method for changing the capacity of the container 4 while keeping the volume of the container 4 constant, for example, involves providing a piston or the like inside of the container 4, and changing the volume of the space that takes the gas 3 inside the container 4 using the piston or the like.

As described above, with the battery 10, the pressure inside of the case 2 can be controlled using the opening/closing means 5 and the container 4, and depending on the case, also using various sensors, means for processing the measurement results of the sensors, discharging means, delivering means, and means for controlling the opening and closing of the opening/closing means 5 based on the measurement results of the sensors, or the like. Accordingly, with the battery 10, these may also be included in the pressure controlling mechanism.

The pressure controlling mechanism is preferably configured to be able to control the pressure inside of the case 2 within a range equal to or greater than 0.1 kg/cm² and equal to or less than 40 kg/cm². If the pressure of the gas 3 that pressurizes the battery pack 1 becomes too low, the battery characteristics of the battery cells provided in the battery pack 1 may deteriorate. On the other hand, if the pressure of the gas 3 that pressurizes the battery pack 1 becomes too high, the case 2 or the battery cells provided in the battery pack 1 may crack, and the battery characteristics of the battery cells provided in the battery pack 1 may change.

Conceivable methods for adjusting the range of the pressure inside of the case 2 that can be controlled by the pressure controlling mechanism to within the range described above involve adjusting the opening and closing conditions of the opening/closing means 5, the capacity or number of the containers 4, and the amount of the gas 3 filled in advance into the case 2 and the container 4, for example.

With the battery 10, a fluctuation in the pressure inside of the case 2 is able to be reduced by providing the pressure controlling mechanism described above. Therefore, with the battery 10 it is possible to inhibit the problem described above from occurring due to the pressure that is applied to the battery cells inside of the case 2 from becoming too low or too high.

### 2. Second Example Embodiment

FIG. 2 is a view schematically showing the structure of a battery 20 according to a second example embodiment of the invention. In FIG. 2, structure that is the same as structure in FIG. 1 will be denoted by like reference characters and descriptions of such structure will be omitted as appropriate.

The battery 20 may be similar to the battery 10 except for that a container 14 and a conduit 6 are provided outside of a case 2, instead of the container 4. Also, the conduit 6 is not particularly limited as long as it is a conduit through which the gas 3 can flow. Therefore, in the description of the battery 20 below, only the container 14 will be described.

The container 14 may be similar to the container 4 except for the position in which it is provided. The container 14 may also have the same function as the container 4. However, the container 14 is provided outside of the case 2, so even if the volume of the container 14 is changed, the volume of the space in which the gas 3 is filled inside of the case 2 will not change as it does with the container 4. However, the gas 3 is able to flow between the case 2 and the container 14, and the gas 3 is filled inside of the case 2 and inside of the container 14, so the volume of the entire space where the gas 3 is can be changed by changing the capacity of the container 14 while the opening/closing means 5 is open. As a result, the pressure inside of the case 2 can be controlled also by changing the capacity of the container 14. According to this mode, the pressure inside of the case 2 can be adjusted also by changing the capacity of the container 14, in addition to the gas 3 flowing in and out between the case 2 and the container 14, so the pressure inside of the case 2 is able to be finely controlled. Also, the change in the pressure inside of the case 2 is easy to visually recognize if the capacity of the container 14 is changed by changing the volume of the container 14.

The battery 20 is provided with a pressure controlling mechanism similar to the pressure controlling mechanism provided in the battery 10, except for the conduit 6 and the container 14 being provided instead of the container 4. Like the battery 10, the battery 20 is able to reduce fluctuation in the pressure inside of the case 2. Therefore, with the battery 20 it is possible to inhibit the problem described above from occurring due to the pressure that is applied to the battery cells inside of the case 2 from becoming too low or too high.

In the first example embodiment, the container 4 is provided inside of the case 2, and in the second example embodiment, the container 14 is provided outside of the case 2. In this way, with the battery of the invention, the container may be provided either inside or outside of the case. If the container is provided inside of the case, the portion that protrudes out of the case can be reduced, making it easier to arrange the battery in various locations. Also, it is less likely that the connecting structure between the case and the container will break, so durability and reliability are improved. On the other hand, if the container is provided outside of the case, the structure of the battery becomes simple, making manufacture and maintenance easier.

### 3. Other Example Embodiments

In the description of the example embodiments of the invention heretofore, the pressure controlling mechanism includes the container 4 or 14 that the gas 3 inside of the case 2 is able to flow into and out of, but the invention is not limited to this. For example, the pressure controlling mechanism may also include releasing means, not shown, for releasing the gas 3 in the case 2 outside of the case 2 (e.g., into the atmosphere), and supplying means, not shown, for supplying the gas into the case 2. The releasing means is not particularly limited as long as it is means for releasing the gas 3 that is inside of the case 2 outside of the case 2 based on the pressure inside of the case 2. A valve that is mechanically or electrically controlled or the like, for example, may be used for this kind of releasing means. Providing this releasing means in the case 2 enables the gas 3 to be released from the case 2 so that the pressure inside of the case 2 can be lowered to a suitable pressure, if the pressure inside of the case 2 becomes too high. Also, the supplying means is not particularly limited as long as it is means for supplying the gas into the case 2 based on the pressure inside of the case 2. A canister filled with the gas 3 at a high density or the like, for example, may be used for this kind of supplying means. Providing this supplying means in the case 2 enables the gas 3 to be supplied into the case 2 so that the pressure inside of the case 2 can be raised to a suitable pressure, if the pressure inside of the case 2 becomes too low. The supplying means may be provided inside or outside of the case 2.

The battery of the invention may be used as a battery of a mobile device, an electric vehicle, or a hybrid vehicle, or the like.

1. A battery comprising:
a battery cell;
a case in which the battery cell is housed and that is filled with a gas that pressurizes the battery cell; and
a pressure controlling mechanism capable of controlling pressure inside of the case.

2. The battery according to claim 1, wherein the pressure controlling mechanism includes at least one container that the gas inside of the case is able to flow into and out of; the at least one container allows the gas to flow in and out via an opening and closing portion; and the opening and closing portion opens and closes based on a pressure inside of the case, a pressure inside of the container, or a difference in the pressure inside of the case and the pressure inside of the container.

3. The battery according to claim 2, wherein the at least one container is a plurality of containers; and each of the plurality of containers allows the gas inside of the case to flow in and out via a different opening and closing portion for each container.

4. The battery according to claim 2 or 3, wherein the container is provided inside of the case.

5. The battery according to claim 2 or 3, wherein the container is provided outside of the case.

6. The battery according to any one of claims 2 to 5, wherein a volume of the container is variable.

7. The battery according to any one of claims 2 to 6, wherein the pressure controlling mechanism includes a delivery portion that forcibly delivers the gas inside of the case into the container.

8. The battery according to any one of claims 2 to 7, wherein the pressure controlling mechanism includes a discharging portion that forcibly discharges gas inside of the container into the case.

9. The battery according to any one of claims 2 to 8, wherein the opening and closing portion includes a first valve that closes by being pushed toward an inside of the container by an elastic body, and a second valve that closes by being pushed toward an outside of the container by an elastic body.

10. The battery according to any one of claims 1 to 9, wherein the pressure controlling mechanism includes a releasing portion capable of releasing gas inside of the case outside of the case based on the pressure inside of the case, and a supply portion capable of supplying gas into the case based on the pressure inside of the case.

11. The battery according to any one of claims 1 to 10, wherein the battery is a lithium-ion battery.
